(19) United States
(12) Patent Application Publication
(10) Pub. No.: US 2007/0106692 A1
(43) Pub. Date: May 10, 2007

(54) System and method for recording and replaying a session with a web server without recreating the actual session

(75) Inventor: Paul Fredric Klein, Newbury Park, CA (US)

Correspondence Address: VANLEEUWEN & VANLEEUWEN, P.O. BOX 90609, AUSTIN, TX, 78709-0609, US

(73) Assignee: International Business Machines Corporation

(21) Appl. No.: 11/271,612

(22) Filed: Nov. 10, 2005

(51) Int. Cl. G06F 17/00

(52) U.S. Cl. 707/104.1

(57) ABSTRACT

A system, method, and computer program product for replaying sessions is presented. Stored page metadata, corresponding to a previous client session, is obtained. One or more of the inputs referenced in the stored page metadata is disabled, resulting in a first replay representation. One or more stored client transactions corresponding to the stored page metadata is also retrieved. The first replay representation is modified based upon the stored client transactions, resulting in a second replay representation. The first and second replay representations are rendered, using a browser.

### BACKGROUND OF THE INVENTION

1. Technical Field

The present invention relates in general to a system and method for replaying a session without recreating the session. More particularly, the present invention relates to a system and method that records data relating to an HTTP session with a web server, and then replays the HTTP session without recreating the actual session.

2. Description of the Related Art

More and more companies, both large and small, are developing web applications that allow their customers and clients to perform on-line operations and business transactions. For example, most banks allow their customers to view their accounts, transfer money, update their address, order checks, and perform many other banking transactions over the Internet. Financial management companies typically provide web applications that allow their clients to manage their portfolios, trade stocks, and update personal information, such as their address, using the web application.

Unfortunately, corporate web applications are not fool-proof. Occasionally, a customer or a client has a problem using the web application. Sometimes the problem is an operational problem with the web application, such as poor performance, a system crash, a network outage, or depletion of buffer pools, storage, or CPU threshold. Other times, the problem is a logical problem, such as poor web application logic, broken or missing links, client error, returned pages with cryptic error messages, blank web pages, or partially rendered web pages. Logical problems such as these are difficult to detect using traditional application, resource manager, and operational monitoring solutions. Therefore, logical problems often result in the customer making a call to the company's help desk for assistance in resolving the problem.

Help desk professionals typically resolve computer application problems by talking to a customer on the telephone (or sometimes via an on-line chat session), and attempting to walk the customer through the problem. The difficulty with this technique is that the help desk professional can not physically see the customer's computer monitor, and therefore must interpret what the customer is saying in an effort to determine the interaction between the customer and the corporate web application, and the resulting display. This type of problem determination is time consuming and error-prone, as it is often difficult for the help desk professional to interpret the customer's rendition of the problem. Sometimes a help desk professional will attempt to recreate the customer's problem, however, it is not always possible to make the same error occur again. In addition, it is not always desirable to recreate an error. For example, if the customer was attempting to transfer money from one account to another account when the error occured, the help desk professional may inadvertently transfer the sum of money several times in an attempt to recreate the error.

Furthermore, help desks are one of the more expensive dealings that a company has with customers, and many companies attempt to avoid having customers deal with help desk professionals. Companies use voice automation systems and on-line knowledge bases to avoid assigning a help desk professional to a customer problem. In those cases where a help desk professional is needed, companies attempt to limit the amount of time that the help desk professional must actually spend working directly with the customer.

What is needed, therefore, is a system and method that reduces the cost of help desk operations by minimizing the amount of time that a help desk professional must spend with a customer when analyzing and attempting to solve the customer's problem.

### SUMMARY

It has been discovered that the aforementioned challenges are resolved using a method for replaying sessions. The method obtains stored page metadata corresponding to a previous client session. One or more of the inputs referenced in the stored page metadata is disabled, resulting in a first replay representation. The method further retrieves one or more stored client transactions corresponding to the stored page metadata. The method modifies the first replay representation based upon the stored client transactions, resulting in a second replay representation. The first and second replay representations are rendered, using a browser.

In another embodiment, the aforementioned challenges are resolved using an information handling system capable of executing the method described above. In yet another embodiment, the aforementioned challenges are resolved using a computer program product stored in a computer operable media, and containing instructions which, when executed by computer, cause the computer to execute the method described above.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a network diagram depicting users interacting with a web application and a help desk system;

FIG. 2 is a flow chart depicting saving metadata pertaining to a session;

FIG. 3 is a flow chart depicting retrieving session data regarding a particular session that is to be replayed;

FIG. 4 is a flowchart depicting rendering, or replaying, a session on a browser without recreating the session;

FIG. 5 is a flowchart depicting traversing a session;

FIG. 6 is a diagram showing a browser replaying a session as the session is traversed; and

FIG. 7 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

The present invention is a method, system, and computer program product that records page metadata regarding a session and then uses the metadata to replay the session without recreating it. A help desk professional sees an almost mirror image of a customer's computer monitor from a window on the help desk's own monitor. This allows the help desk to see what happened on the customer's screen when an error occurred. Thus, the help desk does not have to interpret the customer's description of the problem, but rather, can replay the interaction between the customer and the web application. The help desk is able to observe the problem, and can even “rewind” and observe the problem over again if necessary to resolve the problem.

Replaying, rather than recreating, a problem has several advantages. Some problems are difficult to recreate, and so being able to replay the problem allows a help desk professional to observe what happened, even if the help desk professional is unable to make the problem reoccur. Also, in some cases it is not desirable to recreate the problem, as this may have unintended consequences, such as causing transactions to occur numerous times while trying to duplicate the error. By replaying the session, the help desk can see what happened without having to recreate the problem.

Recording metadata in order to replay a session has many uses, and is not limited to the help desk field. For example, a software developer may replay a testing session to observe errors that occurred while testing. In a testing situation, it is often very difficult to recreate an error, as many errors are caused by timing problems that are difficult to recreate. However, by replaying a testing session, a developer is able to observe an error, many times if necessary, in an attempt to discover what went wrong.

As used herein, the term “client” is used to denote the entity that is interacting with an application, such as a corporate web application. Those skilled in the art will understand that a client includes, but is not limited to, a user, a customer, an employee, a computing device, such as a computer system or a client computer, or a pervasive device, such as a personal digital assistant (PDA) or web-enabled mobile phone.

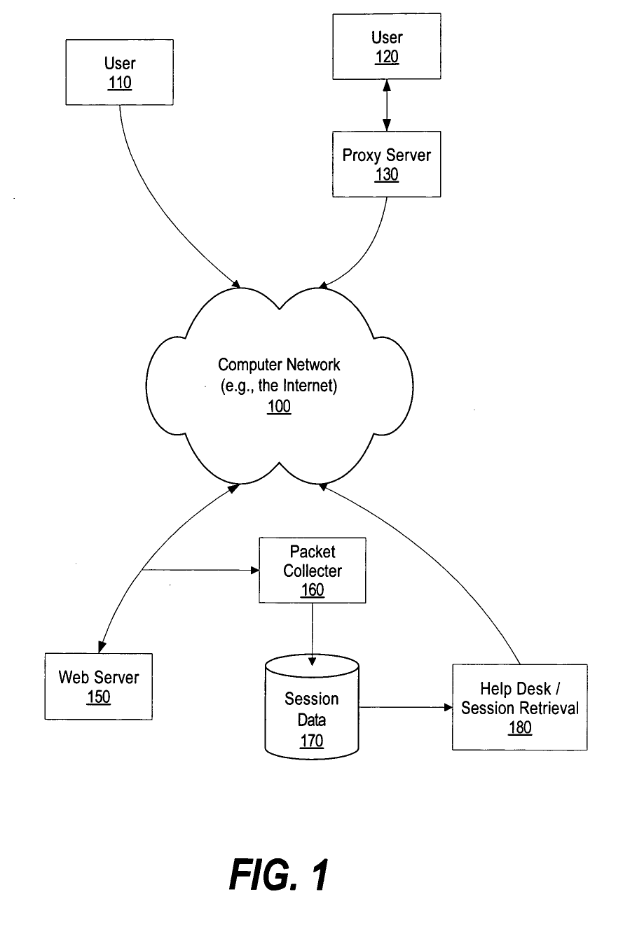

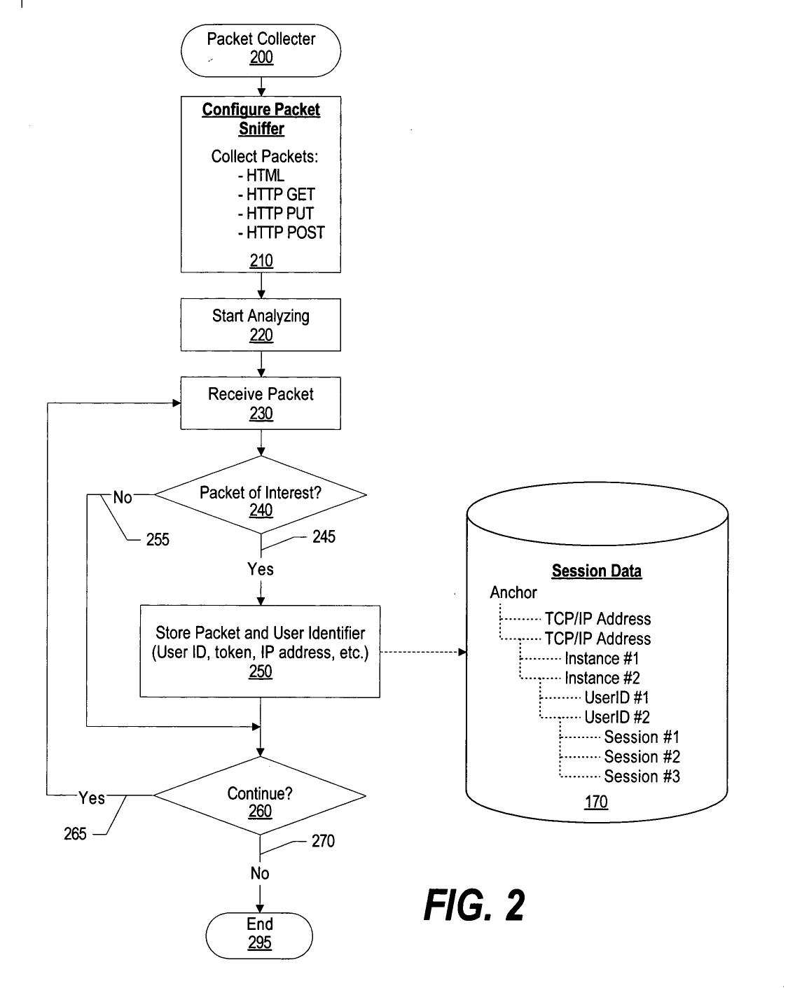

FIG. 1 is a network diagram depicting users interacting with a web application and a help desk system. Computer network 100 connects user 110 and user 120 to web server 150. Note that computer network 100 may be the Internet, an intranet, a virtual private network (VPN), a wireless network, or some other type of network. User 120 is connected to computer network 100 via proxy server 130. User 110 and user 120 may be client computers or any type of computing device, including wireless computing devices, that interact with web server 150. Web server 150 hosts and runs a corporate web application (not shown) with which user 110 and user 120 interact. Help desk 180 is also connected to computer network 100. Packet collector program 160 captures session data 170 as it flows between web server 150 and users 110 and 120, typically by using a network packet sniffer program, as discussed below with reference to FIG. 2. Help desk 180 uses session data 170 to replay a session in order to analyze and resolve any problems encountered by users 110 and 120. Note that help desk 180, web server 150, and packet collector 160 may all be present on the same computing device, or may be present on any number of computing devices.

FIG. 2 is a flow chart depicting saving metadata pertaining to a session. Processing commences at 200, whereupon a packet collector program configures a packet sniffer to filter and collect particular packets (step 210). A packet sniffer, or network sniffer, is a program that captures, monitors, and analyzes network traffic. Packet sniffers selectively capture data as it is being transmitted over a network, such as computer network 100 (shown in FIG. 1). A variety of known packet sniffers may be configured to capture the data depicted in step 210. In the depicted embodiment, a packet sniffer is configured to collect HTML packets, HTTP GET packets, HTTP PUT packets, and HTTP POST packets. The packet collector program may be set up to collect all such HTML and HTTP packets, or, alternatively, the packet collector program may only be interested in collecting these packets for particular users, sessions, etc.

The packet collector program analyzes the packets that are collected by the packet sniffer (step 220). A packet is received (step 230) and a determination is made regarding whether the received packet is a packet of interest (decision 240). As discussed above, the packet collector program may be interested in all HTML and HTTP GET, PUT, and POST packets, or only those that pertain to a particular user or setting. If it is determined that the packet is not a packet of interest, decision 240 branches to “no” branch 255, whereupon processing continues at decision 260. If, however, it is determined that the packet is a packet of interest, then decision 240 branches to “yes” branch 245, whereupon the packet and its user identifier information is stored in session data 170 (step 250). A decision is made regarding whether to continue collecting packets (decision 260). If it is determined to continue collecting packets, decision 260 branches to “yes” branch 265, whereupon processing continues at step 230. If, however, the packet collector program has collected sufficient packets, or has been stopped, decision 260 branches to “no” branch 270, whereupon processing ends at 295.

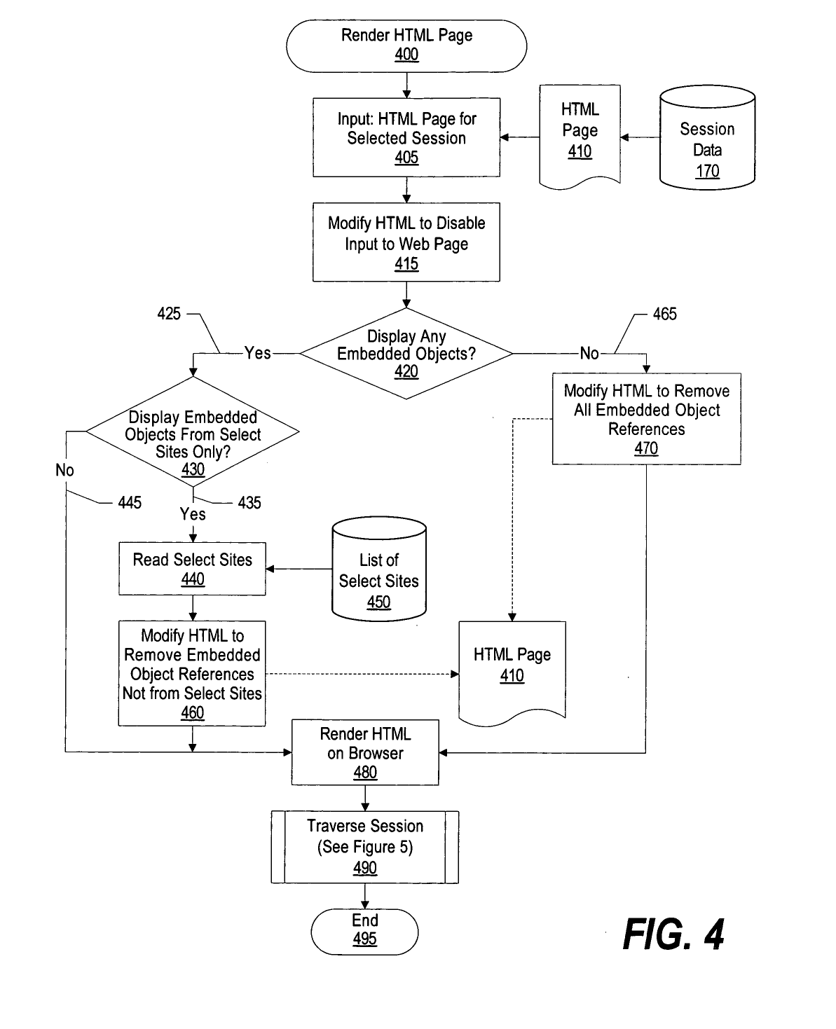

The packet data stored in session data 170 is preferably referred to as “page metadata.” This is because session data 170 does not include every packet or every transaction between users 110 and 120 and web server 150. Rather, only selected packets are collected and stored. The selected packets, in this example HTML packets, and HTTP GET, PUT, and POST packets, are the packets necessary to reconstruct and replay a session. A significant amount of storage space is saved by only collecting and storing selected packets, rather than recording everything that passes between users 110 and 120 and web server 150. In particular, many embedded graphic objects are not stored in session data 170, which saves much storage space, as graphics objects typically consume large amounts of storage. As described below in FIG. 4, embedded graphic objects can be obtained later, if needed.

The page metadata that is stored in session data store 170 can include various user identification data. For example, each HTML and HTTP GET, PUT, and POST packet may be stored, along with a TCP/IP address, instance level, userID, and session number. The user identification data that is stored will depend on the application being monitored. Some applications will have userIDs associated with them, while other applications will have instance levels in addition to, or instead of, UserIDs.

An example showing the type of data that can be stored as page metadata is depicted in session data 170. In this exemplary embodiment, the Anchor is a pointer that points to, or anchors, the data that has been stored. Typically, the Anchor is a memory address that is stored in a known location. Each individual session is identified by a TCP/IP network address. Thus, in the list depicted in session data 170, there are two main entries, each denoted by a TCP/IP address. There are two instances of a recording shown for the second TCP/IP address. For example, one may have been recorded yesterday and one may have been recorded today. Instance #2 has more than one UserID associated with it, possibly because more than one user is reusing the same TCP/IP address (for example, this may occur when using a proxy server, such as proxy server 130, depicted in FIG. 1). For UserID #2, the user may have logged on or off the web server several times, resulting in several sessions. In the example shown UserID #2 has three stored sessions that may be replayed. Each of these sessions includes stored page metadata, such as HTML packets, and HTTP GET, PUT, and POST packets.

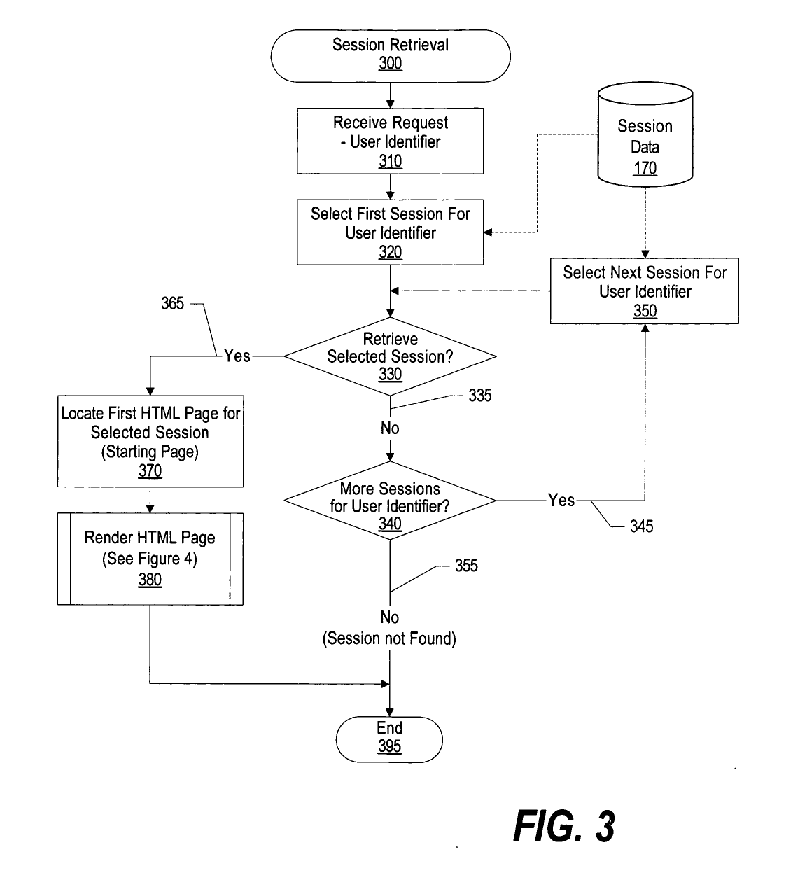

FIG. 3 is a flow chart depicting retrieving session data regarding a particular session that is to be replayed. Processing commences at 300, whereupon a request is received based upon particular user identifier data (step 310). The request may come, for example, from a help desk professional who is trying to diagnose a customer problem. The user identifier may be a userID or other type of identifier, such as TCP/IP address, session ID, etc. The session retrieval program scans session data 170 and selects the first session for the received user identifier (step 320). A determination is made as to whether the selected session is the session in question and should be retrieved, i.e. the session which the help desk professional is attempting to analyze (decision 330). If the selected session is not the session to be retrieved, decision 330 branches to “no” branch 335, whereupon a further determination is made regarding whether there is metadata stored in session data 170 pertaining to other sessions for the user identifier (decision 340). If there are no other sessions for the user identifier, decision 340 branches to “no” branch 355, indicating that the session data of interest was not found, and processing ends at 395. If, however, there is more metadata stored in session data 170 that pertains to other sessions for the user identifier, decision 340 branches to “yes” branch 345, whereupon the session retrieval program selects the next session for the user identifier (step 350).

Returning to decision 330, if the selected session is the session of interest, decision 330 branches to “yes” branch 365, whereupon the session retrieval program locates the first HTML page for the selected session (referred to as the starting page) (step 370). The HTML page is then replayed (predefined process 380), as depicted in FIG. 4, and processing ends at 395.

FIG. 4 is a flowchart depicting rendering, or replaying, a session on a browser without recreating the session. The network packets that are recorded and stored in session data 170 (as discussed above, with reference to FIG. 3), are used to playback a session. In the described embodiment, the HTML and HTTP packets that are saved as page metadata are used to construct replay representations that are sent to a browser. The browser renders the replay representations so that they can be viewed as the customer saw them. In the described embodiment, the stored HTML packets contain the information needed to construct a web page, and the stored HTTP packets are used to reconstruct the customer interactions with the web application.

Processing begins at 400, whereupon HTML page 410 is retrieved from session data 170 (step 405). Processing modifies the HTML to disable input to the web page (step 415). This may be done, for example, by adding an HTML tag to the page that makes it a read-only page. Disabling input to the web page is a security precaution that prevents anyone who is replaying the web page from actually interacting with it. Next, a determination is made as to whether to display any embedded objects referenced in the web page (decision 420). Embedded objects are typically graphics objects. The help desk professional, or other professional who is replaying the session, may decide to display all embedded objects, just some embedded objects, or no embedded objects. It may be that the embedded objects are not needed to resolve a problem, and for efficiency reasons, it may be quicker to only display some of the objects, or perhaps not to display any embedded objects. The decision regarding whether or not to display embedded objects may be made by checking a setting or flag that is pre-selected by the help desk professional, or that is selected as an option during the replay process.

If it is determined not to display any embedded objects, decision 420 branches to “no” branch 465, whereupon HTML page 410 is modified to remove all embedded object references (step 470). Processing then continues at step 480. If it is decided to display some, or all, of the embedded objects, then decision 420 branches to “yes” branch 425, whereupon a further decision is made regarding whether to display embedded objects from select sites only (decision 430). For example, it may be efficient to only display embedded objects that are found on local web sites. Alternately, the help desk professional may determine a list of select sites from which embedded objects should be displayed in order to better analyze the current problem. If it is determined to display all embedded objects, rather than just those from select sites, decision 430 branches to “no” branch 445, whereupon processing continues at step 480. If, however, it is determined to only display objects from selected sites, decision 430 branches to “yes” branch 435, whereupon a list of select sites 450 is read (step 440). For example, list 450 may contain a list of sites from which to retrieve embedded objects. Alternately, list 450 may indicate that only “local” objects, i.e. those objects found on local sites, should be retrieved. Processing then modifies HTML page 410 to remove the embedded object references for those embedded objects which are not from selected sites (step 460).

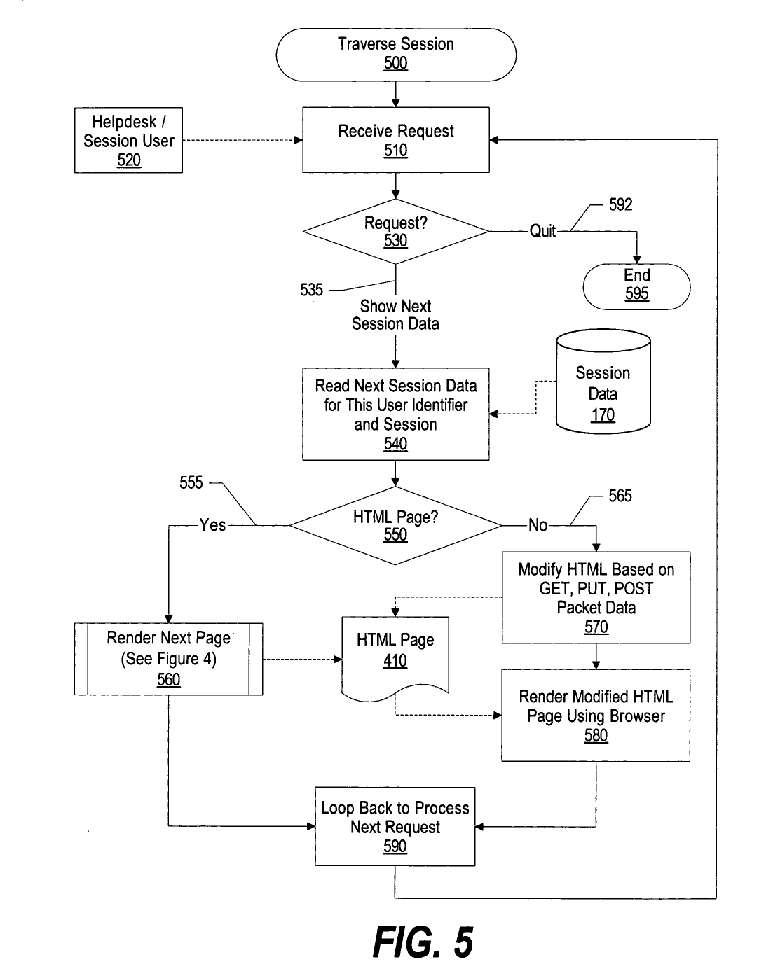

The resulting HTML page, referred to as a first replay representation, is then sent to a browser, typically on the help desk professional's display (step 480). The replay representation is then rendered, i.e. replayed, by the browser, without actually recreating the session. The browser replays the page without recreating, or rerunning, the session with the corporate web application. Processing then continues by traversing the session (predefined process 490) as shown in FIG. 5. Processing then ends at 495.

FIG. 5 is a flowchart depicting traversing a session. Processing commences at 500, whereupon a request is received (step 510) from helpdesk/session user 520. The request is analyzed (decision 530) to determine what type of request has been received. If the request is a “quit” request, decision 530 branches to “quit” branch 592, whereupon processing ends at 595. If, however, the request is to show the next session data, decision 530 branches to branch 535, whereupon the next session data that corresponds to the user identifier and session is read (step 540) from session data 170. A determination is made regarding whether the next session data is an HTML page (decision 550). If the next session data is an HTML page, decision 555 branches to “yes” branch 555, whereupon the next HTML page is rendered (predefined process 560) as shown in FIG. 4.

If the next session data is not an HTML page, then this means the next session data must be an HTTP GET, PUT, or POST packet. In this case, decision 550 branches to “no” branch 565, whereupon HTML page 410 is further modified based on the GET, PUT, or POST data (step 570). In a typical interaction between a customer (i.e. client or user) and a web application, the customer interacts with a web page by filling in a form and/or checking display boxes. These are reflected in the HTTP GET, PUT, and POST protocols. As depicted in step 570, in order to replay the image that the customer saw, the HTTP GET, PUT, and POST packets stored in session data 170 are used. The information found in the HTTP GET, PUT, and/or POST packets is inserted into the modified HTML page (i.e. the HTML that has already been modified and rendered as shown in FIG. 4). The modified HTML page is further modified, for example, by using a Java script, to insert the data from the HTTP GET, PUT, and/or POST packets into the HTML. One way to do this is to take the user input request and turn it into a user output request. This is preferably accomplished by reformatting the HTTP header for the user input request (such as an HTTP POST) and then adding an “HTML tag” next to the field that describes the input typed by the user, thus making this a read-only field.

The further modified HTML page, referred to as a second replay representation, is then rendered using a browser (step 580). Processing then loops back to process the next request (step 590). It is important to note that the HTTP GET, PUT, and POST packets are never sent from the browser to the actual web server application. If the HTTP GET, PUT, and/or POST packets were sent to the web server application, then this may duplicate the functions that the customer had already done. By recording and replaying the interactions between the customer and the web server application, without actually recreating the interactions, the help desk professional can see what happened without interacting with the web server application and potentially duplicating customer transactions.

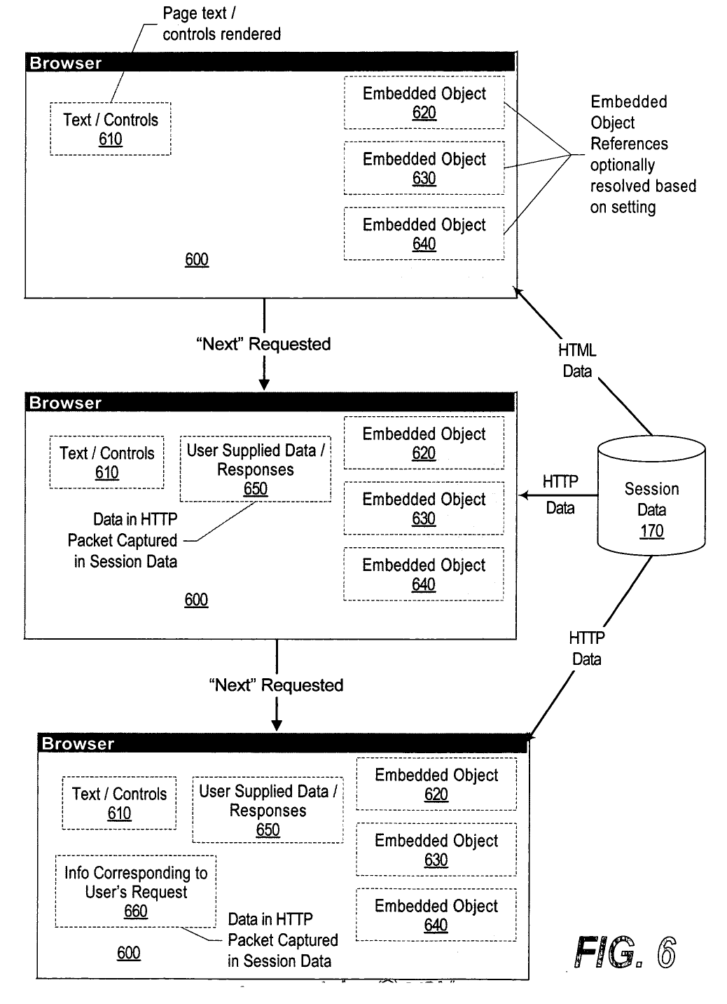

FIG. 6 is a diagram showing a browser replaying a session as the session is traversed. A help desk professional replays a session using browser 600. Session data 170 is used to retrieve HTML data which is displayed on browser 600, as shown in the top depiction. This depiction, of a first replay representation, includes page text/controls 610, along with several embedded objects 620, 630, and 640 that are referred to by embedded object references. As discussed above with reference to FIG. 5, embedded objects 620, 630, and 640 are optionally displayed based on a setting.

The help desk professional then selects a “next” option, by selecting a button (not shown) on his or her display screen. The HTTP packets from session data 170 are then used, as described above with reference to FIG. 5, to display a second replay representation. As depicted in the middle depiction of FIG. 6, browser 600 is used to render the second replay representation, which includes text/controls 610, and optional embedded objects 620, 630, and 640. In addition, the second replay representation includes user supplied data/responses 650, obtained from the data in HTTP packets that were captured and stored as part of the page metadata in session data 170.

The help desk professional continues to traverse the session, and, in this example, a third replay representation is shown in the bottom depiction of FIG. 6. This replay representation is also replayed on browser 600, and includes text/controls 610, optional embedded objects 620, 630, and 640, and user supplied data/responses 650. This third replay representation further includes information corresponding to a user's request 600, that was returned from the web application. This information is also obtained from HTTP data packets that were captured and stored in as page metadata in session data 170. The examples depicted in FIG. 6 are illustrative only, and those skilled in the art will understand that various combinations of replay representations may be traversed, depending on the web applications and the actual user interactions with the web applications.

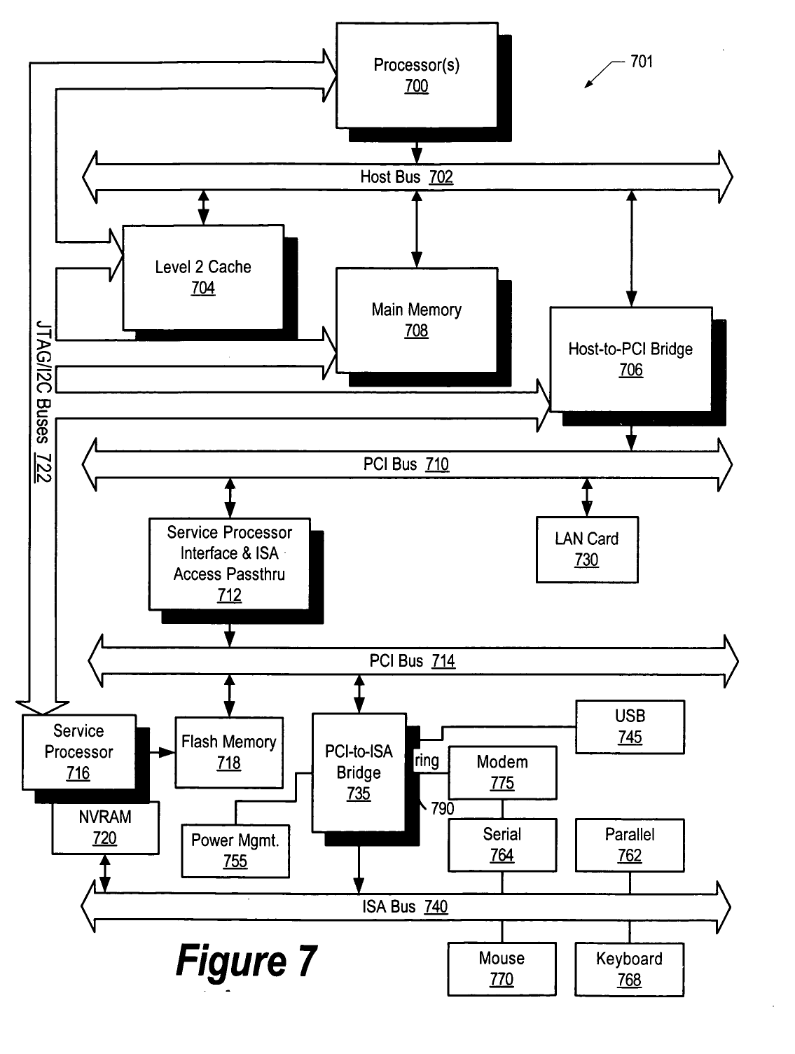

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the processes described herein, this computer system is simply one example of a computer system. Those skilled in the art will appreciate that many other computer system designs are capable of performing the processes described herein.

While the information handling system described in FIG. 7 is capable of executing the processes described herein, this design is simply one example of a computer system design. Those skilled in the art will appreciate that many other computer system designs are capable of performing the processes described herein.

One of the preferred implementations of the invention is an application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method for replaying sessions, said method comprising:
obtaining stored page metadata corresponding to a previous client session;
disabling one or more inputs referenced in the stored page metadata, the disabling resulting in a first replay representation;
retrieving one or more stored client transactions corresponding to the stored page metadata;
modifying the first replay representation based upon the stored client transactions, the modifying resulting in a second replay representation; and
rendering, using a browser, the first and second replay representations.

2. The method of claim 1, further comprising:
determining if there are one or more embedded object references included in the stored page metadata;
in response to determining that there are embedded object references included in the stored page metadata, checking a reference setting to determine whether to inhibit or display one or more embedded objects associated with the embedded object references; and
in response to determining that display of one or more of the embedded objects should be inhibited, modifying the first replay representation by removing the embedded object references associated with the embedded objects that are to be inhibited.

3. The method of claim 2 wherein checking the reference setting further comprises checking the reference setting to determine if embedded objects from one or more sources should be inhibited, and wherein the modifying includes removing one or more embedded object references associated with the sources.

4. The method of claim 1, further comprising:
configuring a packet sniffer to collect packets sent between a first computer and a second computer;
receiving the collected packets from the packet sniffer, wherein each of the collected packets includes a user identification; and
storing the received packets as the stored page metadata.

5. The method of claim 4 wherein the collected packets are selected from the group consisting of HTML packets, HTTP GET packets, HTTP PUT packets, and HTTP POST packets.

6. The method of claim 4 wherein the user identification includes identification data selected from the group consisting of a TCP/IP address, an instance number, a user ID, and a session ID.

7. The method of claim 1 wherein the first replay representation is an HTML page and wherein modifying the first replay representation based upon the stored client transactions further comprises:
inserting data from one or more HTTP packets into the first replay representation before rendering the second replay representation using the browser.

8. The method of claim 1, wherein the rendering further comprises:
displaying the first replay representation in a browser window on a display;
receiving a user request to traverse to a next replay representation; and
in response to the user request, displaying the second replay representation in the browser window on the display.

9. An information handling system comprising:
one or more processors;
a memory accessible by the processors;
a storage device accessible by the processors; and
a tool for replaying sessions, the tool being effective to:
obtain stored page metadata corresponding to a previous client session;
disable one or more inputs referenced in the stored page metadata, the disabling resulting in a first replay representation;
retrieve one or more stored client transactions corresponding to the stored page metadata;
modify the first replay representation based upon the stored client transactions, the modifying resulting in a second replay representation; and
render, using a browser, the first and second replay representations.

10. The information handling system of claim 9, wherein the tool is further effective to:
determine if there are one or more embedded object references included in the stored page metadata;
in response to determining that there are embedded object references included in the stored page metadata, check a reference setting to determine whether to inhibit or display one or more embedded objects associated with the embedded object references; and
in response to determining that display of one or more of the embedded objects should be inhibited, modify the first replay representation by removing the embedded object references associated with the embedded objects that are to be inhibited.

11. The information handling system of claim 10 wherein the tool further checks the reference setting to determine if embedded objects from one or more sources should be inhibited, and wherein the tool modifies the first replay presentation by removing one or more embedded object references associated with the sources.

12. The information handling system of claim 9, wherein the tool is further effective to:
configure a packet sniffer to collect packets sent between a first computer and a second computer;
receive the collected packets from the packet sniffer, wherein each of the collected packets includes a user identification; and
store the received packets as the stored page metadata.

13. The information handling system of claim 12 wherein the collected packets are selected from the group consisting of HTML packets, HTTP GET packets, HTTP PUT packets, and HTTP POST packets.

14. The information handling system of claim 12 wherein the user identification includes identification data selected from the group consisting of a TCP/IP address, an instance number, a user ID, and a session ID.

15. The information handling system of claim 9 wherein the first replay representation is an HTML page and wherein the tool modifies the first replay representation based upon the stored client transactions by inserting data from one or more HTTP packets into the first replay representation before rendering the second replay representation using the browser.

16. The information handling system of claim 9, wherein the tool renders the first and second replay representations by being further effective to:
display the first replay representation in a browser window on a display;
receive a user request to traverse to a next replay representation; and
in response to the user request, display the second replay representation in the browser window on the display.

17. A computer program product stored on a computer operable media, the computer operable media containing instructions for execution by a computer, which, when executed by the computer, cause the computer to implement a method for replaying sessions, the method comprising:
obtaining stored page metadata corresponding to a previous client session;
disabling one or more inputs referenced in the stored page metadata, the disabling resulting in a first replay representation;
retrieving one or more stored client transactions corresponding to the stored page metadata;
modifying the first replay representation based upon the stored client transactions, the modifying resulting in a second replay representation; and
rendering, using a browser, the first and second replay representations.

18. The computer program product of claim 17, wherein the method further comprises:
determining if there are one or more embedded object references included in the stored page metadata;
in response to determining that there are embedded object references included in the stored page metadata, checking a reference setting to determine whether to inhibit or display one or more embedded objects associated with the embedded object references; and
in response to determining that display of one or more of the embedded objects should be inhibited, modifying the first replay representation by removing the embedded object references associated with the embedded objects that are to be inhibited.

19. The computer program product of claim 18 wherein checking the reference setting further comprises checking the reference setting to determine if embedded objects from one or more sources should be inhibited, and wherein the modifying includes removing one or more embedded object references associated with the sources.

20. The computer program product of claim 17, wherein the method further comprises:
configuring a packet sniffer to collect packets sent between a first computer and a second computer;
receiving the collected packets from the packet sniffer, wherein each of the collected packets includes a user identification; and
storing the received packets as the stored page metadata.

21. The computer program product of claim 20 wherein the collected packets are selected from the group consisting of HTML packets, HTTP GET packets, HTTP PUT packets, and HTTP POST packets.

22. The computer program product of claim 20 wherein the user identification includes identification data selected from the group consisting of a TCP/IP address, an instance number, a user ID, and a session ID.

23. The computer program product of claim 17 wherein the first replay representation is an HTML page and wherein modifying the first replay representation based upon the stored client transactions further comprises:
inserting data from one or more HTTP packets into the first replay representation before rendering the second replay representation using the browser.

24. The computer program product of claim 17, wherein the rendering further comprises:
displaying the first replay representation in a browser window on a display;
receiving a user request to traverse to a next replay representation; and
in response to the user request, displaying the second replay representation in the browser window on the display.
